(19) United States
(12) Patent Application Publication
(10) Pub. No.: US 2026/0056795 A1
(43) Pub. Date: Feb. 26, 2026

(54) METHOD AND SYSTEM FOR EVALUATING ADEQUACY OF CLOUD COMPUTING RESOURCES ALLOCATION

(71) Applicant: Accenture Global Solutions Limited, Dublin (IE)

(72) Inventors: Garima SARASWAT, Pune (IN); Khushboo ARORA, Karnal (IN); Hemant Chandrakant PATIL, Pune (IN); Sarang Padmakar JOSHI, Pune (IN); Suvadeep BASU, Kolkata (IN); Ninad SHASHIKANT KULKARNI, Pune (IN); Sachin Dnyaneshwar MOHOD, Pune (IN); Ramoji Rao YALAMATI, Hyderabad (IN)

(21) Appl. No.: 18/812,863

(22) Filed: Aug. 22, 2024

(51) Int. Cl. G06F 9/50

(52) U.S. Cl. CPC G06F 9/5033

(57) ABSTRACT

The present disclosure discloses a computer implemented method and system to evaluate adequacy of cloud computing resources allocation. The method includes extracting a set of features and a set of target variables from a historic dataset stored in a database. Further, the method includes generating a plurality of simple linear regression (SLR) model and a multiple linear regression (MLR) model. Furthermore, a respective value of each target variable of the set of target variables is determined based on the SLR model and MLR model. Thereafter, the method includes calculating a new value of each feature of the set of features followed by generating adequacy score by comparing the new value of each feature of the set of features with a desired value of each feature of the set of features.

### TECHNICAL FIELD

Various embodiments described herein relate generally to environment adequacy prediction. Specifically, a computer implemented method and a system for evaluating adequacy of cloud computing resources allocation by using artificial intelligence (AI), and machine learning (ML) techniques, is disclosed.

### BACKGROUND

Cloud computing has revolutionized the way IT operations operate, offering unprecedented scalability and flexibility. However, effectively allocating cloud resources to meet application demands while optimizing resource utilization remains a complex challenge. Traditional approaches heavily rely on user-driven inputs and lack the ability to accurately predict performance, leading to suboptimal resource utilization and unexpected cost overruns. Thus, accurately forecasting the computational needs of applications is difficult. Fluctuations in workload, user behavior, and external factors make it challenging to provision the right number of resources.

### SUMMARY

Implementations of the present disclosure are generally directed to evaluating adequacy of cloud computing resources allocation by using artificial intelligence (AI) and machine learning (ML) techniques.

In general, innovative aspects of the subject matter described in this specification provide a computer implemented method for evaluating adequacy of cloud computing resources allocation. The method may include extracting a set of features and a set of target variables from a historic dataset stored in a database. Further, the method may include generating a plurality of simple linear regression models, based upon a respective value of each feature of the set of features stored in the database, corresponding to each target variable of the set of target variables. Additionally, a multiple linear regression model may be generated based upon the respective value of each feature of the set of features stored in the database, corresponding to the set of target variables. Moreover, based on, at least in part, upon the plurality of simple linear regression models and based on, at least in part, upon the multiple linear regression model, a respective value of each target variable of the set of target variables may be determined. The method also includes calculating a new value of each feature of the set of features based upon the respective value of each target variable of the set of target variables. Furthermore, the method includes generating an adequacy score based on comparing the new value of each feature of the set of features with a desired value of each feature of the set of features. Herein, the adequacy score indicates whether the respective value of each target variable of the set of target variables satisfies a user specified requirement for the each target variable.

The present disclosure further describes a system for implementing the method provided herein. The present disclosure also describes a non-transitory computer-readable media (CRM) having instructions stored thereon which, when executed by the one or more processors, cause the one or more processors to perform operations in accordance with the method described herein.

It is appreciated that methods in accordance with the present disclosure can include any combination of the aspects and features described herein. That is, the method in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### DRAWINGS

Various embodiments in accordance with the present disclosure will be described with reference to the drawings, in which:

FIG. 1 illustrates an example environment that may be used to execute implementations of the present disclosure.

FIG. 2 illustrates an exemplary flow diagram of traditional method of determining cloud computing resources allocation.

FIG. 3 illustrates an exemplary flow diagram of a method of evaluating adequacy of cloud computing resources allocation in accordance with implementations of the present disclosure.

FIG. 4 illustrates a block diagram for evaluating adequacy of cloud computing resources allocation system, in accordance with implementations of the present disclosure.

FIG. 5 illustrates a flow diagram of determining adequacy score in accordance with implementations of the present disclosure.

FIG. 6 illustrates a flow diagram of an example method for evaluating adequacy of cloud computing resources allocation in accordance with implementations of the present disclosure.

FIG. 7 illustrates an exemplary embodiment determining adequacy score in accordance with implementations of the present disclosure.

FIG. 8 illustrates a computer system that may be used to implement the method for evaluating adequacy of cloud computing resources allocation in accordance with implementations of the present disclosure, in accordance with implementations of the present disclosure.

Like reference numbers and designations in the various drawings indicate like elements.

### DETAILED DESCRIPTION

In the following description, various embodiments will be illustrated by way of example and not by way of limitation in the figures of the accompanying drawings. References to various embodiments in this disclosure are not necessarily to the same embodiment, and such references mean at least one. While specific implementations and other details are discussed, it is to be understood that this is done for illustrative purposes only. A person skilled in the relevant art will recognize that other components and configurations may be used without departing from the scope of the claimed subject matter.

Reference to any “example” (e.g., “for example”, “an example of”, by way of example” or the like) are to be considered non-limiting examples regardless of whether expressly stated or not.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any exemplified term. Likewise, the disclosure is not limited to various embodiments given in this specification.

Without intent to limit the scope of the disclosure, examples of instruments, apparatus, methods, and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

The term “comprising” when utilized means “including, but not necessarily limited to”; it specifically indicates open-ended inclusion or membership in the so-described combination, group, series and the like.

The term “a” means “one or more” unless the context clearly indicates a single element.

“First,” “second,” etc., are labels to distinguish components or blocks of otherwise similar names but does not imply any sequence or numerical limitation.

“And/or” for two possibilities means either or both of the stated possibilities (“A and/or B” covers A alone, B alone, or both A and B take together), and when present with three or more stated possibilities means any individual possibility alone, all possibilities taken together, or some combination of possibilities that is less than all of the possibilities. The language in the format “at least one of A . . . and N” where A through N are possibilities means “and/or” for the stated possibilities (e.g., at least one A, at least one N, at least one A and at least one N, etc.).

It should also be noted that in some alternative implementations, the functions/acts noted may occur out of the order noted in the figures. For example, two steps disclosed or shown in succession may in fact be executed substantially concurrently or may sometimes be executed in the reverse order, depending upon the functionality/acts involved.

Specific details are provided in the following description to provide a thorough understanding of embodiments. However, it will be understood by one of ordinary skill in the art that embodiments may be practiced without these specific details. For example, systems may be shown in block diagrams so as not to obscure the embodiments in unnecessary detail. In other instances, well-known processes, structures, and techniques may be shown without unnecessary detail in order to avoid obscuring example embodiments.

The specification and drawings are to be regarded in an illustrative rather than a restrictive sense. It will, however, be evident that various modifications and changes may be made thereunto without departing from the broader spirit and scope of the invention as set forth in the claims.

Cloud computing has revolutionized the way businesses operate, offering unprecedented scalability and flexibility. However, effectively allocating cloud resources to meet dynamic workloads while optimizing resources remains a complex challenge. Known methods of determining cloud computing resources allocation heavily rely on user input and lack the ability to accurately predict performance and resource allocation. This results in suboptimal resource utilization, potential performance bottlenecks, and unexpected cost overruns.

To address the challenges of the known methods, there is a need for a solution that can intelligently evaluate cloud resource adequacy, optimize resource allocation, and provide actionable insights. Such a solution would significantly improve the efficiency and resource allocation for cloud deployments.

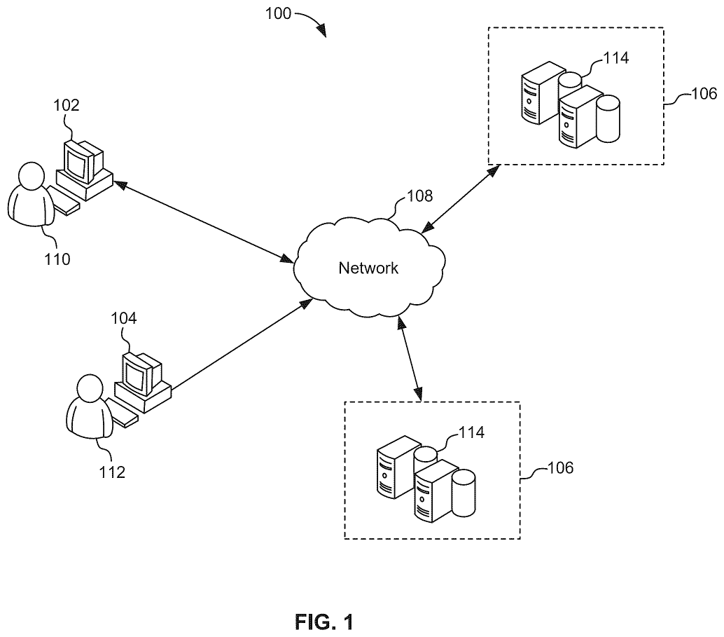

FIG. 1 depicts an example environment 100 that can be used to execute implementations of the present disclosure. In some examples, the example environment 100 enables users associated with respective systems to execute requests to generate content by invoking a trained language model in accordance with implementations of the present disclosure. The example environment 100 includes computing devices 102 and 104, back-end systems 106, and a network 108. In some examples, the computing devices 102 and 104 are used by respective users 110 and 112 to log into and interact with the platforms and running applications according to implementations of the present disclosure.

In the depicted example, the computing devices 102 and 104 are depicted as desktop computing devices. It is contemplated, however, that implementations of the present disclosure can be realized with any appropriate type of computing device (e.g., smartphone, tablet, laptop computer, voice-enabled devices). In some examples, the network 110 includes a local area network (LAN), wide area network (WAN), the Internet, or a combination thereof, and connects web sites, user devices (e.g., computing devices 102, 104), and back-end systems (e.g., the back-end systems 106). In some examples, the network 108 can be accessed over a wired and/or a wireless communications link. For example, mobile computing devices, such as smartphones can utilize a cellular network to access the network 108.

In the depicted example, the back-end systems 106 each include at least one server system 114. In some examples, the at least one server system 114 hosts one or more computer implemented services that users can interact with by using computing devices. For example, components of enterprise systems and applications can be hosted on one or more of the back-end systems 106. In some examples, a back-end system can be provided as an on-premises system that is operated by an enterprise or a third-party taking part in cross-platform interactions and data management. In some examples, a back-end system can be provided as an off-premises system (e.g., cloud or on-demand) that is operated by an enterprise or a third-party on behalf of an enterprise.

In some examples, the computing devices 102 and 104 each include computer-executable applications executed thereon. In some examples, the computing devices 102 and 104 each include a web browser application executed thereon, which can be used to display one or more web pages of platform running applications. In some examples, each of the computing devices 102 and 104 can display one or more graphical user interfaces (GUIs) that enable the respective users 110 and 112 to interact with the computing platform. In accordance with implementations of the present disclosure, the back-end systems 106 may host enterprise applications or systems that require data sharing and data privacy. In some examples, the computing device 102 and/or the computing device 104 can communicate with the back-end systems 106 over the network 108.

In some implementations, at least one of the back-end systems 106 can be implemented in a cloud environment that includes at least one server system 114. In the example of FIG. 1, the back-end server 106 can represent various forms of servers including, but not limited to, a web server, an application server, a proxy server, a network server, and/or a server pool. In general, server systems accept requests for application services and provide such services to any number of client devices (for example, the computing device 102 over the network 108).

In some implementations, the back-end system 106 can be used to implement an Artificial Intelligence (AI)-enabled platform trained to generate content relevant for individuals in accordance with contextual information and training data indicative of reactions of similar consenting individuals to certain content items (e.g., neuroscience responses). The AI-enabled platform can include a trained AI model that generates such personalized content. The AI model can be trained using a training corpus that combines data representing, for example, neuroscience responses of the individuals to stimuli triggered by various content items and corresponding context data acquired from a plurality of sources.

Various examples depicting evaluation of adequacy of cloud computing resources allocation, are described in detail in conjunctions with figures below.

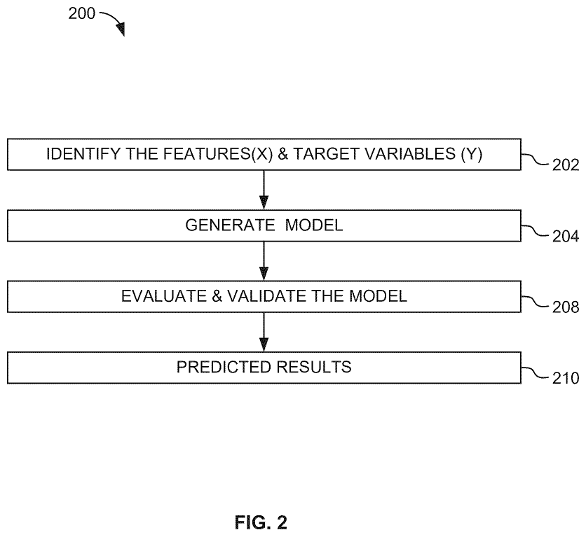

FIG. 2 illustrates an exemplary flow diagram of a traditional method (or a known method) 200 of determining cloud computing resources allocation. The traditional method 200 includes, at step 202, extracting data, and identifying features (X) and target variables (Y). Further, at step 204, a model is generated using fundamental information (for example, the type of data, and the desired outcome). Thereafter, at step 206, the generated model is evaluated and validated to assess its performance. Consequently, at step 208, the model generates predicted results based on the input data.

The traditional method 200 of determining cloud computing resources allocation presents several technical problems. Specifically, the traditional method 200 relies solely on the model's predictions without considering real-world performance metrics thereby, leading to uncertainty about whether the allocated resources will be sufficient. Also, the traditional method 200 lacks correlating performance parameters, workload, and resource utilization, thereby leading to ineffective resource allocation and optimization.

In view of this, implementations of the present disclosure provide a method to evaluate adequacy of cloud computing resources allocation by deriving an adequacy score. A method is disclosed herein for evaluating cloud computing resource allocation using both Simple Linear Regression (SLR) and Multiple Linear Regression (MLR) models. The SLR model determines relationship between each individual feature and the target variable, thereby, identifying key drivers of the target variable and potential areas for optimization. Furthermore, MLR model captures the combined effect of multiple features on the target variable, for identifying interactions and dependencies among multiple features. In essence, use of SLR and MLR models can be used to explore different feature engineering approaches, leading to potential improvements in model performance.

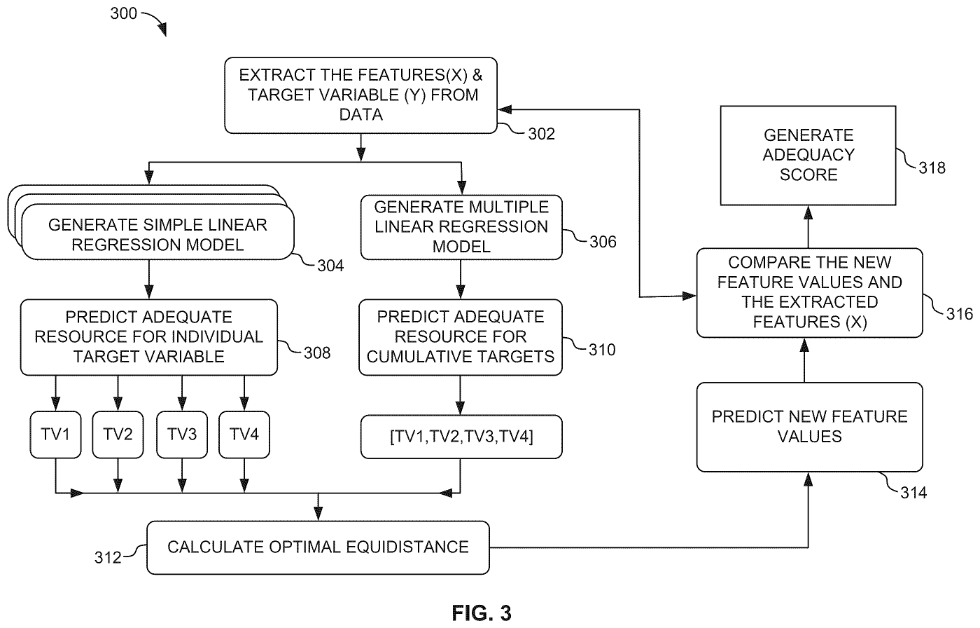

FIG. 3 illustrates an exemplary flow diagram of a method 300 of evaluating adequacy of cloud computing resources allocation in accordance with implementations of the present disclosure.

In the method 300, at step 302, data may be extracted, and a set of features (X) and a set of target variables (Y) may be identified. The data may be extracted from a historic dataset stored in a database. Specifically, the set of features (X) may be the independent variables that can used to predict the set of target variables (Y). The set of features (X) may represent characteristics of cloud computing resources, or the workload being processed. The non-limiting examples of the set of features (X) may include ram, storage capacity, number of requests, data volume, response time, number of requests, data volume, response time, or the like. Furthermore, the set target variables (Y) may be the dependent variables that is to be predicted. The set target variables (Y) may represent performance metrics associated with cloud computing resource allocation. Non-limiting examples of target variables may include latency (time taken for a request to be processed), throughput (number of requests that can be handled per unit time), application response time (time taken by an application to respond to a user request), or the like.

At step 304, a plurality of simple linear regression (SLR) models may be generated, based upon a respective value of each feature of the set of features stored in the database, corresponding to each target variable of the set of target variables. Moreover, at step 306, a multiple linear regression (MLR) model is generated based upon the respective value of each feature of the set of features stored in the database. Herein, the plurality of SLR model and the MLR may generate simultaneously. Specifically, SLR model may be a statistical model that relates a single feature of the set of features (X) to a dependent target variable of the set of target variable (Y), through a linear equation. The SLR model considers a linear relationship between each feature of the set of features (X) and each variable of the set of target variables (Y). Moreover, the MLR model may be a statistical model that relates multiple features of the set of features (X) to a dependent target variable of the set of target variables (Y) through a linear equation. The MLR model may analyze the multiple features of the set of features (X) collectively predict the set of target variables (Y).

Thereafter, in method 300, at step 308, an individual adequate resources value corresponding to each target variable of the set of target variables (TV1, TV2, TV3 and TV4) may be generated by a respective SLR model of the plurality of SLR models. Further, at step 310, a cumulative adequate resources value of corresponding to each target variable of the set of target variables (TV1, TV2, TV3 and TV4) may generated by the MLR model. Thereafter, at 312, an optimal equidistance/mean values may be calculated between the individual adequate resources value variables and the cumulative adequate resources value and at step 314 identify a new value of each feature of the set of features may be identified. At step 316, the extracted data features (at step 302) and the new value of each feature of the set of features may be compared followed by generating, at step 318, an adequacy score. Specifically, the adequacy score may be the ratio of summation of extracted feature values (X) with the new value of each feature of the set of features. Consequently, the adequacy score may determine whether the predicted adequate resources are exactly sufficient, more than sufficient, or less than sufficient.

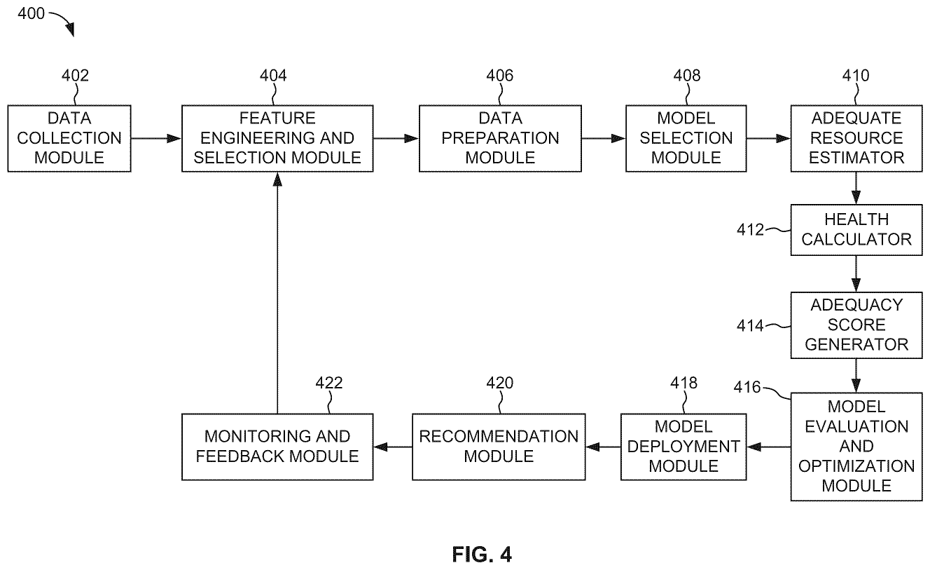

FIG. 4 illustrates a block diagram for evaluating adequacy of cloud computing resources allocation system 400, in accordance with implementations of the present disclosure. The system 400 includes a data collection module 402, a feature engineering and selection module 404, a data preparation module 406, a model selection module 408, an adequate resource estimator 410, a health calculator 412, an adequacy score generator 414, a model evaluation and optimization module 416, a model deployment module 418, a recommendation module 420 and a monitoring and feedback module 422.

Specifically, the system 400 may include processors and memories communicatively coupled to the processors. Moreover, the system 400 may include a non-transitory computer-readable media (CRM) having instructions stored thereon which, when executed by the processors, cause the processors to perform operations. Further, the memory comprises processor-executable instructions which, when executed by the processor, may cause the processor extracting a set of features and a set of target variables from a historic dataset stored in a database. Further, the system 400 may include generating a plurality of simple linear regression models, based upon a respective value of each feature of the set of features stored in the database, corresponding to each target variable of the set of target variables. Additionally, a multiple linear regression model may be generated based upon the respective value of each feature of the set of features stored in the database, corresponding to the set of target variables. Moreover, based on, at least in part, upon the plurality of simple linear regression models and based on, at least in part, upon the multiple linear regression model, a respective value of each target variable of the set of target variables may be determined. The system 400 may also include calculating a new value of each feature of the set of features based upon the respective value of each target variable of the set of target variables. Furthermore, the system 400 may include generating an adequacy score based on comparing the new value of each feature of the set of features with a desired value of each feature of the set of features. Herein, the adequacy score indicates whether the respective value of each target variable of the set of target variables satisfies a user specified requirement for each target variable.

In further detail, the data collection module 402 may collect data from on-premises and cloud system. Specifically, the data may include historical data and performance data of environment configuration of both on-premises and cloud system. The data may include metrics related to resource utilization, workload patterns, and performance indicators. Further, the feature engineering and selection module 404 may extract the relevant set of features and the set of target variables from the collected data. The relevant set of features may exhibit a correlation with performance. The set of features may include, but not limited to, a number of concurrent users for a preconfigured or predetermined time duration, a total data volume for the preconfigured or predetermined time duration, and/or a number of busy hours for the preconfigured or predetermined time duration. The set of target variables may include, but not limited to, a central processor unit (CPU) usage, a memory usage, a network usage, a disk size, latency of accessing the cloud computing resources, and/or an input/output per second (IOPS) using the cloud computing resources. Specifically, the feature engineering and selection module 404 may apply feature engineering techniques (for example, variable transformation, discretization, feature splitting or the like) to transform raw collected data into relevant information for use by machine learning (ML) models. The feature engineering and selection module 404 may extract most relevant set of features for the predictive task under consideration and select a subset of target variables to train a ML model with the purpose of maximizing model generalizability and optimization.

Thereafter, the data preparation module 406 may prepare the data in the format suitable for the ML model development. Specifically, the data is formatted to align with the requirements of ML models. The data preparation module 406 may implement various data cleaning and preprocessing techniques, such as imputation for missing data or missing values and address outliers thereby improving efficiency of model predictions.

In further detail, the model selection module 408 employs a data-driven approach to determine the most suitable ML model for the given task. Based on a comprehensive analysis of the prepared data, the model selection module 408 may identify a linear correlation between features and target variables. Consequently, Simple Linear Regression (SLR) is selected as the optimal modeling technique. Therefore, a plurality of simple linear regression (SLR) model may generate, based upon a respective value of each feature of the set of features stored in the database, corresponding to each target variable of the set of target variables. Specifically, for each target variable of the set of target variables, separate individual SLR model is created. Additionally, correlation between the features and the target variables is identified for prediction.

Moreover, the model selection module 408 may select multiple linear egression (SLR) as optimal modelling technique and generate the multiple linear regression (MLR) model, based upon the respective value of each feature of the set of features stored in the database, corresponding to the set of target variables. Specifically, the MLR model may include a combination of each target variable of the set of target variables to generate the single MLR model and considers correlation between the features and target variables for prediction.

Thereafter, the adequate resource estimator 410 may determine the respective value of each target variable of the set of target variables, based on at least in part upon the plurality of SLR models and based on at least in part upon the MLR model. Specifically, determining the respective value of each target variable of the set of target variables may include determining a mean value/optimal equidistance, using an equidistance calculation formula, for each target variable based on a first set of values and a second set of value of each target variable, wherein the first set of value corresponds with a value of a respective target variable determined using the SLR model, and wherein the second set of value corresponds with a value of the respective target variable determined using the MLR model. In some examples, the equidistance calculation formula may be identified as:

$$M = X - ( Z / 2 )$$

Wherein, M denotes the mean value;
X denotes the value of extracted features; and
Z denotes the absolute difference between the first set of values and the second set of values.

The mean value may refer to a new value of a target variable of the set of target variables corresponding to original extracted each feature of the set of features stored in the database, based on which the optimal adequate resources are identified. Herein, the mean value may represent optimal adequate cloud computing resources required to be allocated in order to meet the computational needs of applications. Additionally, the mean value may input to the health calculator 412 which calculated a new value of each feature of the set of features. Herein the health calculator 412 may be a machine learning (ML) model which is trained using data patterns derived from the historic dataset and a plurality of cloud computing environment performance parameters along with the mean value. Herein, generating the new value of each feature may create a more dynamic and adaptable evaluation of adequate cloud computing resources. Specifically, the initial relevant set of features and the set of target variables were extracted based on historical data and performance data of environment configuration of both on-premises and cloud system. The historic data is static in nature, reflecting past conditions, which may not accurately represent the future cloud computing resources required. Moreover, cloud computing environments are dynamic in nature, with factors like user behavior, external conditions, and resource availability changing rapidly and considering only the historical data may not determine current or future cloud computing resources required. Therefore, the new value of each feature of the set of features may be generated to assess adequacy of cloud computing resources, under different conditions (for example, peak loads, unexpected surges, or the like). Moreover, generating new feature values, the health calculator 412 may analyze different resource configurations, for instance, the resource configurations may include varying level of, but not limited to, CPU (number of processing units available), RAM (capacity of memory available), storage (storage capacity allocated), network bandwidth (data transfer rate available), and other resources (for example depending on the specific cloud platform, there might be additional resources like GPUs, specialized hardware, or specific software components). The health calculator 412 may analyze different resource configurations, for instance, three different resource configurations: configuration 1, configuration 2 and configuration 3. For example, the configuration 1 may include (2 CPU, 4 GB RAM, 100 GB storage, 1 Gbps network bandwidth), configuration 2 may include (4 CPU, 8 GB RAM, 200 GB storage, 2 Gbps network bandwidth) and configuration 3 may include (1 CPU, 2 GB RAM, 50 GB storage, 500 Mbps network bandwidth). The health calculator 412 may evaluating the performance of the different configurations (configuration 1, configuration 2 and configuration 3), and generate new value of each feature of the set of features which includes the combination of resources that meets the application's requirements while optimizing resources.

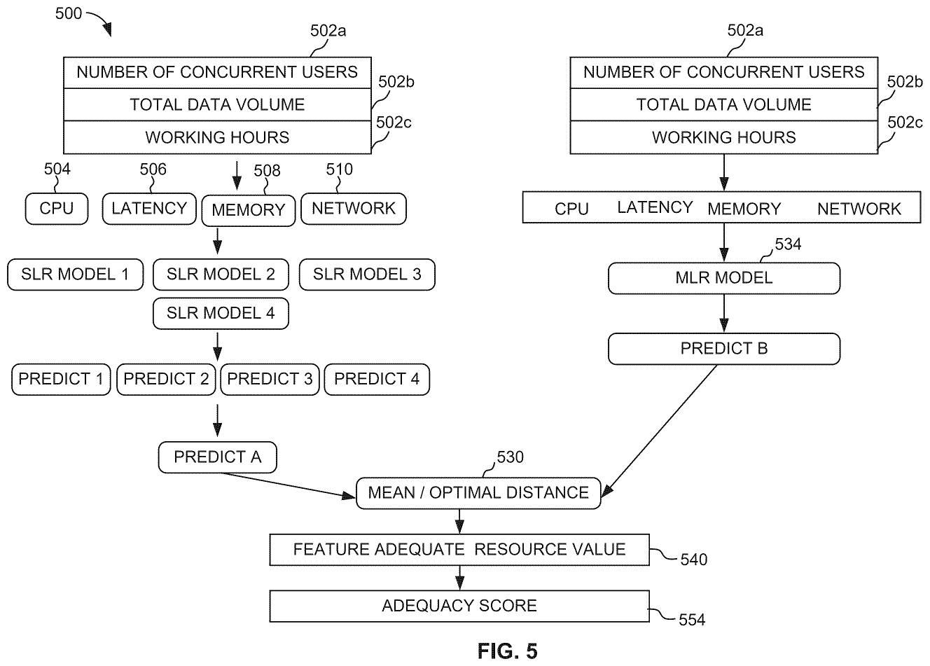

Furthermore, the health calculator 412 may calculate a new value of each feature of the set of features, based upon the respective value (mean value/optimal equidistance) of each target variable of the set of target variables. Calculating the new value of each feature of the set of features may include calculating the new value of each feature of the set of features based upon a respective weightage and the respective value of each target variable of the set of target variables, by utilizing a custom algorithm (described in detail further in conjunction with FIG. 5)

Moreover, the adequacy score generator 414 may compare the new value of each feature of the set of features with original extracted value of each feature of the set of features to generate the adequacy score. The adequacy score may quantify the degree of resource sufficiency, enabling a precise evaluation of whether resources are precisely adequate, excessive, or insufficient. The adequacy score of a value less than 1 indicates the set of target variables fails to satisfy the user specified requirement, the adequacy score of a value 1 indicates the set of target variables sufficiently satisfy the user specified requirement, and/or the adequacy score of a value greater than 1 indicates the set of target variables exceed the user specified requirement. The numerical representation of the discrepancy between predicted and actual resource levels, the adequacy score empowers decision-makers to fine-tune resource allocation strategies, optimize resource utilization, and ensure system reliability.

In further detail, the model evaluation and optimization module 416 may evaluate continuously the performance of health calculator 412 based on the adequacy score, and necessary optimizations are made.

Furthermore, the model deployment module 418 may integrate the health calculator 412 (the trained ML model) into a production environment for real-time evaluation and prediction updates. Specifically, the deployed or integrated, health calculator 412 may continuously evaluate cloud resource allocation in real-time, ensuring that resources are aligned with the application's requirement. Further, if the health calculator 412 detects that resources are insufficient or excessive, it may trigger automatic adjustments to optimize performance. Moreover, as new data becomes available, the health calculator 412 may update the predictions of cloud resource allocation to reflect changing circumstances. In essence, the model deployment module 418 by integrating the health calculator 412 (the trained ML model) into a production environment, may enable the real-time predictions, adapt to dynamic conditions, and integrate seamlessly into the overall cloud management process. Thus, ensuring that the cloud resources are allocated efficiently and effectively to meet the evolving requirements of applications.

In further detail, the model deployment module 418 may include, but not limited to, selecting a deployment platform, model serialization, application programming interface (API) creation, integration with existing systems and security considerations. The selection of a deployment platform may include selecting a suitable platform or infrastructure, such as cloud-based services (AWS, GCP, Azure), containerization (Docker, Kubernetes), or on-premises servers. Specifically, selection of the deployment platform may be based on factors including, but not limited to, model size and complexity, scalability requirements, scalability requirements, and resource constraints. The model serialization may include converting the model into a format compatible with the deployment environment (for e.g., pickle, TensorFlow SavedModel, PyTorch). The API creation may include developing an API or interface to interact with the deployed model, allowing other systems or applications to access its predictions. The integration with existing systems may include connecting the deployed model with relevant data sources and systems to ensure seamless operation. The security considerations may include implementing appropriate security measures to protect the model and the data.

Furthermore, the recommendation module 420 may provide insights into whether the current cloud resources are sufficient to handle the task. The insights are derived from the health calculator 412 predictions and the generated adequacy score by adequacy score generator 414. Specifically, the recommendation module 420 may implement specific actions based on the adequacy score. The specific action may include continuing operations with the current resource allocation, if the resources are adequate (e.g., if the adequacy score is one). The specific action may include increasing the resource allocation (e.g., CPU, memory, storage) to meet the demand, if the resources are insufficient (e.g., if the adequacy score is less than one). Further, the specific action may include decreasing the resource allocation to optimize resource utilization, if the resources are excessive (e.g., if the adequacy score is greater than one).

In further detail, the monitoring and feedback module 422 may continuously monitor the deployed model and incorporate the insights gained from monitoring back into the model development process. The continuously monitoring may include tracking key performance indicators (KPIs) like R-squared (R²), adjusted R² (R²_{Adj}), mean squared error mean absolute error, and other relevant metrics. The continuously monitoring may further include investigating model errors to understand their patterns and improve model performance. More specifically, the monitoring and feedback module 422 may collect information about health calculator 412 performance, user interactions, and other relevant data. Further, the monitoring and feedback module 422 may identify patterns, trends, and areas for improvement. Furthermore, the monitoring and feedback module 422 may update the model with new data and insights, thereby enhancing the accuracy and effectiveness. Subsequently the monitoring and feedback module 422 may integrate the updated model back into the production environment.

FIG. 5 illustrates a block diagram 500 for determining adequacy score in accordance with implementations of the present disclosure. Herein, the block diagram 500 is described in relation to FIG. 4.

The set of input features required for predicting optimal adequacy score may be extracted by data collection module 402, based on historical data. For instance, input features may include, but not limited to, number of concurrent users 502a, total data volume 502b and working hours 502c. Further, the set of corresponding target variables are identified. For instance, the corresponding set of target variable may include, but not limited to CPU 504 (number of CPU count), latency 506 (maximum acceptable delay for a cloud-based service), memory 508 (memory usage required) and network 510 (network usage required) Furthermore, each target variable may be processed individually using simple linear regression (SLR) modelling technique, thereby identifying the relationship between the target variable and each feature independently. For instance, four individual SLR models: SLR model 1, SLR model 2, SLR model 3 and SLR model 4 are generated to process each target variable CPU, latency, memory and network respectively.

Further, the SLR models may generate predictions for each target variable. For instance, the SLR models may generate individual predictions as “Predict 1”, “Predict 2”, “Predict 3”, and “Predict 4” for each target variable CPU, latency, memory and network respectively. The individual predictions (“Predict 1”, “Predict 2”, “Predict 3”, and “Predict 4”) may combine to generate a final prediction (Predict A).

Moreover, each target variable of the set of target variables (e.g., CPU, latency, memory and network) may be processed cumulatively by the model selection module 408 to generate the MLR model 534. For instance, the MLR model 534 may be generated to process the combined effect of the target variables: CPU, latency, memory and network and generate a prediction as “Predict B”. The MLR model 534 may consider the combined effect of the target variable, thereby identifying potential interactions and correlations among the features and the target variables.

Further, the mean value/optimal distance 530 may be determined by the adequate resource estimator 410, based on predictions generated (Predict A and Predict B). Specifically, simple linear regression (SLR) model may demonstrate superior performance when the dataset is characterized by a limited number of target variables. Conversely, multiple linear regression (MLR) model excels in scenarios with a comprehensive set of target variables. Therefore, to leverage the strengths of both the SLR models and MLR models, a mean of their respective predictions may be calculated, thereby, optimizing overall predictive accuracy by effectively combining the complementary capabilities of the two regression modelling techniques (SLR and MLR). The mean value may represent the value of optimal adequate resources required. Moreover, the custom algorithm is implemented by the health calculator 412 to generate a new adequate resource value 540 of each feature of the set of features. The custom algorithm may include iterating through all possible combinations of features. For instance, M is percentage variation between extracted features and the new value of each feature and N is number of instances of variation, then the custom algorithm may include iterating through all possible combinations of features, with a total of M*N iterations. Herein, at each iteration, the algorithm may calculate the proximity of each feature to the target variable. Furthermore, the adequacy score generator may generate adequacy score 554. Specifically, the adequacy score 554 can be the ratio of summation of extracted feature values with the new adequate resource value 540 of each feature of the set of features.

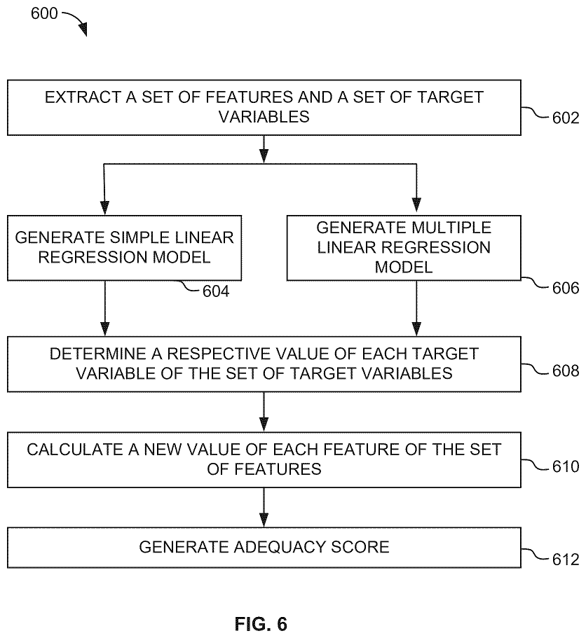

FIG. 6 illustrates the flow diagram of an example method 600 for evaluating adequacy of cloud computing resources allocation, in accordance with implementations of the present disclosure. In some implementations, the method 600 may be executed within the system for evaluating adequacy of cloud computing resources allocation as described in relation to FIG. 4.

At step 602, the method 600 may include extracting a set of features and a set of target variables. Specifically, the data collection module may extract the set of features and the set of target variables based on historical data and performance data of environment configuration of on-premises and cloud system.

At step 604, the method 600 may include generation of a plurality of simple linear regression (SLR) models based upon a respective value of each feature of the set of features stored in the database, corresponding to each target variable of the set of target variables. Specifically, the model selection module 408 may generate the plurality of simple linear regression (SLR) models.

At step 606, the method 600 may include generation of a multiple linear regression (MLR) model, based upon the respective value of each feature of the set of features stored in the database, corresponding to the set of target variables. Specifically, the model selection module 408 may generate the multiple linear regression (MLR) model.

At step 608, the method 600 may include determination of the respective value of each target variable of the set of target variables, based on at least in part upon the plurality of SLR models and based on at least in part upon the MLR models. Specifically, the adequate resource estimator may determine the respective value of each target variable of the set of target variables.

At step 610, the method may include calculating a new value of each feature of the set of features based on the respective value of each target variable of the set of target variables. Specifically, the new value of each feature of the set of features is calculated by the health calculator 412. The health calculator 412 may be a machine learning (ML) model that may be trained using data patterns derived from the historic dataset and a plurality of cloud computing environment performance parameters.

At step 612, the method 600 may include generating an adequacy score. The adequacy score indicates whether the respective value of each target variable of the set of target variables satisfies a user specified requirement for each target variable. Specifically, the adequacy score generator compares the new value of each feature of the set of features (generated by the health calculator 412) with a desired value of each feature of the set of features. Herein, the desired value are the extracted features by the data collection module 402.

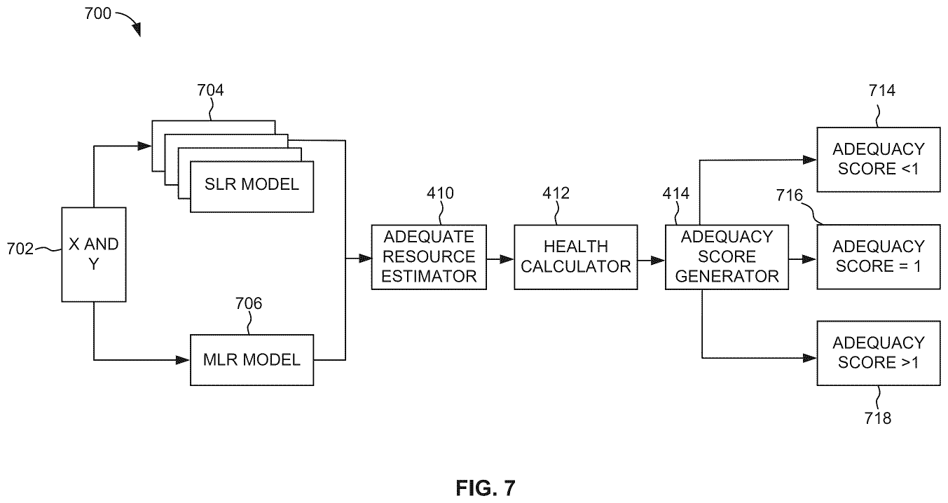

FIG. 7 illustrates an example determining adequacy score 554 in accordance with implementations of the present disclosure. In the example, the set of features (X) and the set of target variables (Y) 702 are extracted. For instance, the set of features “X” may include number of concurrent users, total data volume in GB and working hours with values 4500, 700 and 10 respectively, as the original extracted features. In another instance, the set of target variables “Y” may include number of CPU count, memory in GB, network usage in gbps and latency in milliseconds.

Furthermore, the SLR model 704 may generate a respective value of each target variable of the set of target variables. For example, the SLR model 704 generates a respective value 189.68332032 for the target variable number of CPU count, 227.24579589 for the target variable memory in GB,124.1938226 for the target variable network usage in gbps and 630.62033253 for the target variable latency in milliseconds.

Similarly, the MLR model 706 may generate a respective value of each target variable of the set of target variables. For example, the MLR model 706 generates a respective value 185.46487598 for the target variable number of CPU count, 217.12731257 for the target variable memory in GB, 120.37637769 for the target variable network usage in gbps and 592.35110982 for the target variable latency in milliseconds.

Thereafter, the adequate resource estimator 410 may determine a mean value for each target variable based on a first value and a second value of each target variable. The first value corresponds with a value of a respective target variable determined using the SLR model 704, and the second value corresponds with a value of the respective target variable determined using the MLR model 706. For example, the mean value determined by the the adequate resource estimator 410 can be 187.57409815 for the target variable number of CPU count, 222.18655423 for the target variable memory in GB, 122.28510015 for the target variable network usage in gbps and 611.48572117 for the target variable latency in milliseconds.

Furthermore, the health calculator 412 may calculate a new value of each feature of the set

of features based on the generated mean value by the adequate resource estimator 410. For example, the health calculator 412 may generate a new set of features including number of concurrent users, total data volume in GB and working hours with values 4486,650 and 9 respectively. Consequently, the adequacy score generator 414 may generate an adequacy score by comparing the new value of each feature of the set of features with the extracted value of each feature of the set of features. The adequacy score may quantify the degree of resource sufficiency, enabling a precise evaluation of whether resources are precisely adequate, excessive, or insufficient. Specifically, the adequacy score equal to one 716 may indicate that predicted optimal adequate resources are exactly sufficient, the adequacy score less than one 714 may indicate that predicted optimal adequate resources are lesser than sufficient and the adequacy score greater than one 718 may indicate that predicted optimal adequate resources are more than sufficient.

Implementations of the present disclosure provides technical solutions to multiple technical problems that arise in the context of evaluating adequacy of cloud computing resources allocation. The present disclosure discloses a method for evaluating cloud computing resource allocation using both Simple Linear Regression (SLR) and Multiple Linear Regression (MLR) models. The SLR model determines relationship between each individual feature and the target variable, thereby, identifying key drivers of the target variable and potential arcas for optimization. Furthermore, MLR model captures the combined effect of multiple features on the target variable, thereby identifying interactions and dependencies among features that might be missed by SLR model alone. In essence, use of two different models can be used to explore different feature engineering approaches, leading to potential improvements in model performance. Furthermore, the adequacy score, based on the comparison of actual and desired resource values, provides a quantitative measure of resource allocation effectiveness. The adequacy score can be used to make informed decisions about resource provisioning, scaling, and optimization. Specifically, the adequacy score serves as a quantitative measure of cloud resources allocation alignment with the actual needs of an application or workload. By comparing the adequacy score to specific thresholds (e.g., 1), allows for clear determination of resource overprovision or under provision. Further, by preventing both over and under provisioning, the adequacy score contributes to system stability and performance. In essence, the adequacy score may enable fine-tuning of cloud resource allocation strategies, leading to cost savings, performance improvements, and overall system efficiency.

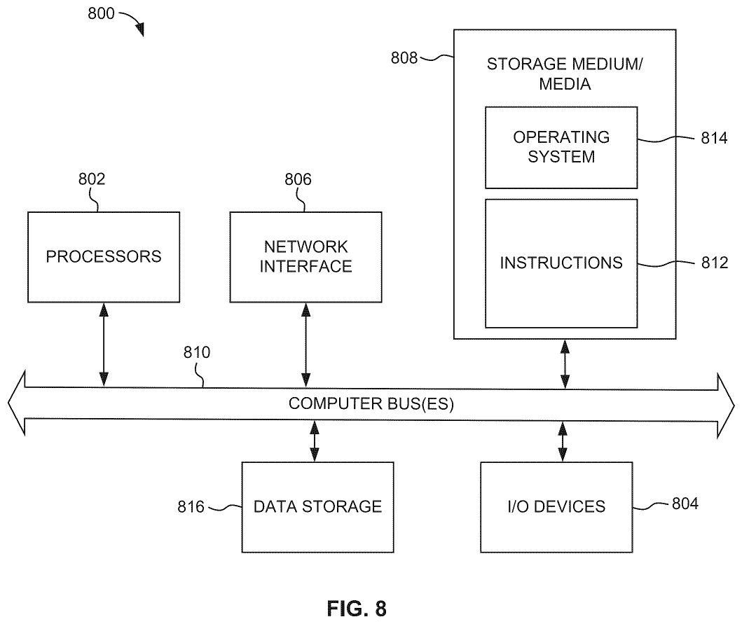

FIG. 8 illustrates a computer system 800 that may be used to implement the system to evaluating adequacy of cloud computing resources allocation. More particularly, computing machines such as desktops, laptops, smartphones, tablets, and wearables which may be used to implement the tasks that may have the structure of the computer system 800. The computer system 800 may include additional components not shown and that some of the process components described may be removed and/or modified. In another example, a computer system 800 may be deployed on external-cloud platforms such as cloud, internal corporate cloud computing clusters, organizational computing resources, and/or the like.

The computer system 800 includes processor(s) 802, such as a central processing unit, ASIC (Application-Specific Integrated Circuit) or another type of processing circuit, input/output devices 804, such as a display, mouse keyboard, etc., a network interface 806, such as a Local Area Network (LAN), a wireless 802.11x LAN, a 3G or 4G mobile WAN or a WiMax WAN, and a computer-readable medium 808. Each of these components may be operatively coupled to a bus 810. The computer-readable medium 808 may be any suitable medium that participates in providing instructions to the processor(s) 802 for execution. For example, the computer-readable medium 808 may be non-transitory or non-volatile medium, such as a magnetic disk or solid-state non-volatile memory or volatile medium such as random access memory (RAM). The instructions or modules stored on the computer-readable medium 808 may include machine-readable instructions 812 executed by the processor(s) 802 that cause the processor(s) 802 to perform the methods and functions of the system to evaluate the adequacy of cloud computing resources allocation.

The system may be implemented as software stored on a non-transitory processor-readable medium and executed by the processors 802. For example, the computer-readable medium 808 may store an operating system 814, such as MAC OS, MS WINDOWS, UNIX, or LINUX, and code for the system. The operating system 814 may be multi-user, multiprocessing, multitasking, multithreading, real-time, and the like. For example, during runtime, the operating system 814 is running and the code for the system is executed by the processor(s) 802.

The computer system 800 may include a data storage 816, which may include non-volatile data storage. The data storage 816 stores any data used or generated by the system.

The network interface 806 connects the computer system 800 to internal systems for example, via a LAN. Also, the network interface 806 may connect the computer system 800 to the Internet. For example, the computer system 800 may connect to web browsers and other external applications and systems via the network interface 806.

What has been described and illustrated herein is an example along with some of its variations. The terms, descriptions, and figures used herein are set forth by way of illustration only and are not meant as limitations. Many variations are possible within the spirit and scope of the subject matter, which is intended to be defined by the following claims and their equivalents.

Implementations and all of the functional operations described in this specification may be realized in digital electronic circuitry, or in computer software, firmware, or hardware, including the structures disclosed in this specification and their structural equivalents, or in combinations of one or more of them. Implementations may be realized as one or more computer program products (i.c., one or more modules of computer program instructions encoded on a computer readable medium for execution by, or to control the operation of, data processing apparatus). The computer readable medium may be a machine-readable storage device, a machine-readable storage substrate, a memory device, a composition of matter effecting a machine-readable propagated signal, or a combination of one or more of them. The term computing system encompasses all apparatus, devices, and machines for processing data, including by way of example a programmable processor, a computer, or multiple processors or computers. The apparatus may include, in addition to hardware, code that creates an execution environment for the computer program in question (e.g., code that constitutes processor firmware, a protocol stack, a database management system, an operating system, or any appropriate combination of one or more thereof). A propagated signal is an artificially generated signal (e.g., a machine-generated electrical, optical, or electromagnetic signal) that is generated to encode information for transmission to suitable receiver apparatus.

A computer program (also known as a program, software, software application, script, or code) may be written in any appropriate form of programming language, including compiled or interpreted languages, and it may be deployed in any appropriate form, including as a stand-alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry (e.g., an FPGA (Field Programmable Gate Array) or an ASIC (Application-Specific Integrated Circuit)).

Processors suitable for the execution of a computer program include, by way of example, both general and special purpose microprocessors, and any one or more processors of any appropriate kind of digital computer. Generally, a processor will receive instructions and data from a read only memory or a random access memory or both. Elements of a computer can include a processor for performing instructions and one or more memory devices for storing instructions and data. Generally, a computer will also include, or be operatively coupled to receive data from or transfer data to, or both, one or more mass storage devices for storing data (e.g., magnetic, magneto optical disks, or optical disks). However, a computer need not have such devices. Moreover, a computer may be embedded in another device (e.g., a mobile telephone, a personal digital assistant (PDA), a mobile audio player, a Global Positioning System (GPS) receiver). Computer readable media suitable for storing computer program instructions and data include all forms of non-volatile memory, media and memory devices, including by way of example semiconductor memory devices (e.g., EPROM, EEPROM, and flash memory devices); magnetic disks (e.g., internal hard disks or removable disks); magneto optical disks; and CD ROM and DVD-ROM disks. The processor and the memory may be supplemented by, or incorporated in, special purpose logic circuitry.

To provide for interaction with a user, implementations may be realized on a computer having a display device (e.g., a CRT (cathode ray tube), LCD (liquid crystal display) monitor) for displaying information to the user and a keyboard and a pointing device (e.g., a mouse, a trackball, a touchpad), by which the user may provide input to the computer. Other kinds of devices may be used to provide for interaction with a user as well; for example, feedback provided to the user may be any appropriate form of sensory feedback (e.g., visual feedback, auditory feedback, tactile feedback); and input from the user may be received in any appropriate form, including acoustic, speech, or tactile input.

Implementations may be realized in a computing system that includes a back end component (e.g., as a data server), a middleware component (e.g., an application server), and/or a front end component (e.g., a client computer having a graphical user interface or a Web browser, through which a user may interact with an implementation), or any appropriate combination of one or more such back end, middleware, or front end components. The components of the system may be interconnected by any appropriate form or medium of digital data communication (e.g., a communication network). Examples of communication networks include a local area network (LAN) and a wide area network (WAN), e.g., the Internet.

The computing system may include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

What is claimed is:

1. A computer-implemented method for evaluating adequacy of cloud computing resources allocation comprising:
extracting, by one or more processors of at least one computing device, from a historic dataset stored in a database, a set of features and a set of target variables;
generating, by the one or more processors, a plurality of simple linear regression models, based upon a respective value of each feature of the set of features stored in the database, corresponding to each target variable of the set of target variables;
generating, by the one or more processors, a multiple linear regression model, based upon the respective value of each feature of the set of features stored in the database, corresponding to the set of target variables;
determining, by the one or more processors, based at least in part upon the plurality of simple linear regression models and based at least in part upon the multiple linear regression model, a respective value of each target variable of the set of target variables;
calculating, by the one or more processors, based upon the respective value of each target variable of the set of target variables, a new value of each feature of the set of features; and
generating, by the one or more processors, based on comparing the new value of each feature of the set of features with a desired value of each feature of the set of features, an adequacy score, wherein the adequacy score indicates whether the respective value of each target variable of the set of target variables satisfies a user specified requirement for the each target variable.

2. The computer-implemented method of claim 1, wherein the set of features includes one or more of: a number of concurrent users for a preconfigured or predetermined time duration, a total data volume for the preconfigured or predetermined time duration, and/or a number of busy hours for the preconfigured or predetermined time duration.

3. The computer-implemented method of claim 1, wherein the set of target variables include one or more of: a central processor unit (CPU) usage, a memory usage, a network usage, a cost associated with cloud computing resources, a disk size, latency of accessing the cloud computing resources, and/or an input/output per second (IOPS) using the cloud computing resources.

4. The computer-implemented method of claim 1, wherein determining the respective value of each target variable of the set of target variables comprises determining a mean value for each target variable based on a first value and a second value of each target variable, wherein the first value corresponds with a value of a respective target variable determined using a simple linear regression model, and wherein the second value corresponds with a value of the respective target variable determined using the multiple linear regression model.

5. The computer-implemented method of claim 1, wherein calculating the new value of each feature of the set of features comprises calculating the new value of each feature of the set of features based upon a respective weightage and the respective value of each target variable of the set of target variables.

6. The computer-implemented method of claim 1, wherein determining the respective value of each target variable of the set of target variables comprises determining the respective value for each target variable using an equidistance calculation formula for a first set of values and a second set of values, wherein the first set of values corresponds with values for the set of target variables determined using the plurality of simple linear regression models, and wherein the second set of values corresponds with values for the set of target variables determined using the multiple linear regression model.

7. The computer-implemented method of claim 1, wherein calculating the new value of each feature of the set of features comprises calculating the new value of each feature of the set of features using a machine learning model that is trained using data patterns derived from the historic dataset and a plurality of cloud computing environment performance parameters.

8. The computer-implemented method of claim 1, wherein the adequacy score of a value less than 1 indicates the set of target variables fails to satisfy the user specified requirement, wherein the adequacy score of a value 1 indicates the set of target variables sufficiently satisfy the user specified requirement, and/or wherein the adequacy score of a value greater than 1 indicates the set of target variables exceed the user specified requirement.

9. A system for evaluating adequacy of cloud computing resources allocation comprising:
at least one memory storing instructions; and
at least one processor communicatively coupled with the at least one memory, and configured to perform operations comprising:
extracting, from a historic dataset stored in a database, a set of features and a set of target variables;
generating a plurality of simple linear regression models, based upon a respective value of each feature of the set of features stored in the database, corresponding to each target variable of the set of target variables;
generating a multiple linear regression model, based upon the respective value of each feature of the set of features stored in the database, corresponding to the set of target variables;
determining, based at least in part upon the plurality of simple linear regression models and based at least in part upon the multiple linear regression model, a respective value of each target variable of the set of target variables;
calculating, based upon the respective value of each target variable of the set of target variables, a new value of each feature of the set of features; and
generating an adequacy score, based on comparing the new value of each feature of the set of features with a desired value of each feature of the set of features, wherein the adequacy score indicates whether the respective value of each target variable of the set of target variables satisfies a user specified requirement for the each target variable.

10. The system of claim 9, wherein the set of features includes one or more of: a number of concurrent users for a preconfigured or predetermined time duration, a total data volume for the preconfigured or predetermined time duration, and/or a number of busy hours for the preconfigured or predetermined time duration.

11. The system of claim 9, wherein the set of target variables include one or more of: a central processor unit (CPU) usage, a memory usage, a network usage, a cost associated with cloud computing resources, a disk size, latency of accessing the cloud computing resources, and/or an input/output per second (IOPS) using the cloud computing resources.

12. The system of claim 9, wherein determining the respective value of each target variable of the set of target variables comprises determining a mean value for each target variable based on a first value and a second value of each target variable, wherein the first value corresponds with a value of a respective target variable determined using a simple linear regression model, and wherein the second value corresponds with a value of the respective target variable determined using the multiple linear regression model.

13. The system of claim 9, wherein calculating the new value of each feature of the set of features comprises calculating the new value of each feature of the set of features based upon a respective weightage and the respective value of each target variable of the set of target variables.

14. The system of claim 9, wherein determining the respective value of each target variable of the set of target variables comprises determining the respective value for each target variable using an equidistance calculation formula for a first set of values and a second set of values, wherein the first set of values corresponds with values for the set of target variables determined using the plurality of simple linear regression models, and wherein the second set of values corresponds with values for the set of target variables determined using the multiple linear regression model.

15. The system of claim 9, wherein calculating the new value of each feature of the set of features comprises calculating the new value of each feature of the set of features using a machine learning model that is trained using data patterns derived from the historic dataset and a plurality of cloud computing environment performance parameters.

16. The system of claim 9, wherein the adequacy score of a value less than 1 indicates the set of target variables fails to satisfy the user specified requirement, wherein the adequacy score of a value 1 indicates the set of target variables sufficiently satisfy the user specified requirement, and/or wherein the adequacy score of a value greater than 1 indicates the set of target variables exceed the user specified requirement.

17. A non-transitory computer-readable media (CRM) having instructions stored thereon, which when executed by at least one processor of at least one computing device, cause evaluating adequacy of cloud computing resources allocation by performing operations comprising:
extracting, from a historic dataset stored in a database, a set of features and a set of target variables;
generating a plurality of simple linear regression models, based upon a respective value of each feature of the set of features stored in the database, corresponding to each target variable of the set of target variables;
generating a multiple linear regression model, based upon the respective value of each feature of the set of features stored in the database, corresponding to the set of target variables;
determining, based at least in part upon the plurality of simple linear regression models and based at least in part upon the multiple linear regression model, a respective value of each target variable of the set of target variables;
calculating, based upon the respective value of each target variable of the set of target variables, a new value of each feature of the set of features; and
generating an adequacy score, based on comparing the new value of each feature of the set of features with a desired value of each feature of the set of features, wherein the adequacy score indicates whether the respective value of each target variable of the set of target variables satisfies a user specified requirement for the each target variable.

18. The non-transitory CRM of claim 17, wherein:
the set of features includes one or more of: a number of concurrent users for a preconfigured or predetermined time duration, a total data volume for the preconfigured or predetermined time duration, and/or a number of busy hours for the preconfigured or predetermined time duration; and
the set of target variables include one or more of: a central processor unit (CPU) usage, a memory usage, a network usage, a cost associated with cloud computing resources, a disk size, latency of accessing the cloud computing resources, and/or an input/output per second (IOPS) using the cloud computing resources.

19. The non-transitory CRM of claim 17, wherein:
determining the respective value of each target variable of the set of target variables comprises determining a mean value for each target variable based on a first value and a second value of each target variable, wherein the first value corresponds with a value of a respective target variable determined using a simple linear regression model, and wherein the second value corresponds with a value of the respective target variable determined using the multiple linear regression model; and
calculating the new value of each feature of the set of features comprises calculating the new value of each feature of the set of features based upon a respective weightage and the respective value of each target variable of the set of target variables.

20. The non-transitory CRM of claim 17, wherein:
determining the respective value of each target variable of the set of target variables comprises determining the respective value for each target variable using an equidistance calculation formula for a first set of values and a second set of values, wherein the first set of values corresponds with values for the set of target variables determined using the plurality of simple linear regression models, and wherein the second set of values corresponds with values for the set of target variables determined using the multiple linear regression model; and
calculating the new value of each feature of the set of features comprises calculating the new value of each feature of the set of features using a machine learning model that is trained using data patterns derived from the historic dataset and a plurality of cloud computing environment performance parameters.
